(19) United States
(12) Patent Application Publication
(10) Pub. No.: US 2015/0163725 A1
(43) Pub. Date: Jun. 11, 2015

(54) METHOD AND APPARATUS FOR INTER RADIO ACCESS TECHNOLOGY (IRAT) BPLMN SEARCH

(71) Applicant: QUALCOMM Incorporated, San Diego, CA (US)

(72) Inventors: Zhang ZHOU, San Diego, CA (US); Thawatt GOPAL, San Diego, CA (US); Yang Ming WANG, San Diego, CA (US); Qingxin CHEN, Del Mar, CA (US)

(73) Assignee: QUALCOMM Incorporated, San Diego, CA (US)

(21) Appl. No.: 14/099,636

(22) Filed: Dec. 6, 2013

(51) Int. Cl. H04W 48/16; H04W 76/04

(52) U.S. Cl. CPC H04W 48/16; H04W 76/048; H04W 84/045

(57) ABSTRACT

The present disclosure presents a method and an apparatus for inter-radio access technology (IRAT) background public land mobile network (BPLMN) re-acquisition mechanism at a user equipment (UE). For example, the method may include performing a BPLMN acquisition mechanism at a UE, checking whether a BPLMN re-acquisition mechanism is valid, determining whether the re-acquisition mechanism requirements are met, and performing the re-acquisition mechanism at the UE. As such, an IRAT BPLMN re-acquisition mechanism at a UE is performed.

### BACKGROUND

Aspects of the present disclosure relate generally to wireless communication systems, and more particularly, to inter radio access technology (IRAT) background public land mobile network (BPLMN) search.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

A background public land mobile network (BPLMN) search is performed during discontinuous reception (DRX) cycles at a user equipment (UE). The BPLMN search can last through hundreds of DRX cycles as only a portion of time during each DRX cycle can be used for BPLMN search and the UE has to suspend the BPLMN search before the current DRX cycle ends. The UE resumes the BPLMN search after the next DRX cycle starts.

During inter-RAT BPLMN search, the time left for BPLMN search is less to account for the overhead of the active and the inactive RATs switch back and forth. For example, the actual time left for BPLMN search when TD-SCDMA is the inactive RAT may be around 200 ms.

Therefore, there is a desire for a method and an apparatus for an autonomous IRAT BPLMN search at a UE.

### SUMMARY

The following presents a simplified summary of one or more aspects in order to provide a basic understanding of such aspects. This summary is not an extensive overview of all contemplated aspects, and is intended to neither identify key or critical elements of all aspects not delineate the scope of any or all aspects. Its sole purpose is to present some concepts of one or more aspects in a simplified form as a prelude to the more detailed description that is presented later.

The present disclosure presents an example method and apparatus for inter-radio access technology (IRAT) background public land mobile network (BPLMN) re-acquisition mechanism at a user equipment (UE). For example, the present disclosure presents an example method for inter-radio access technology (IRAT) background public land mobile network (BPLMN) re-acquisition mechanism at a user equipment (UE) that includes performing a BPLMN acquisition mechanism at a UE, checking whether a BPLMN re-acquisition mechanism is valid based on whether a re-acquisition flag is set, determining whether the re-acquisition mechanism requirements are met, and performing the re-acquisition mechanism at the UE.

In an additional aspect, an apparatus for inter-radio access technology (IRAT) background public land mobile network (BPLMN) re-acquisition mechanism at a user equipment (UE) is disclosed. The apparatus may include means for performing a BPLMN acquisition mechanism at a UE, means for checking whether a BPLMN re-acquisition mechanism is valid based on whether a re-acquisition flag is set, means for determining whether the re-acquisition mechanism requirements are met, and means for performing the re-acquisition mechanism at the UE.

In a further aspect, a computer program product for inter-radio access technology (IRAT) background public land mobile network (BPLMN) re-acquisition mechanism at a user equipment (UE) is described. The computer program product may include a computer-readable medium comprising code executable by a computer for performing a BPLMN acquisition mechanism at a UE, checking whether a BPLMN re-acquisition mechanism is valid based on whether a re-acquisition flag is set, determining whether the re-acquisition mechanism requirements are met, and performing the re-acquisition mechanism at the UE.

Moreover, the present disclosure presents an apparatus for inter-radio access technology (IRAT) background public land mobile network (BPLMN) re-acquisition mechanism at a user equipment (UE). The apparatus may include a BPLMN acquisition component to perform a BPLMN acquisition mechanism at a UE, a BPLMN re-acquisition to checking component to check whether a BPLMN re-acquisition mechanism is valid based on whether a re-acquisition flag is set, a BPLMN re-acquisition requirements component to determine whether the re-acquisition mechanism requirements are met, and a BPLMN re-acquisition performing component to perform the re-acquisition mechanism at the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram illustrating an example wireless system of aspects of the present disclosure;

FIG. 2 is a block diagram illustrating an example inter radio access technology (IRAT) background public land mobile network (BPLMN) search manager;

FIG. 3 is an example flow chart of an optimized inter-radio access technology (IRAT) background public land mobile network (BPLMN) acquisition mechanism at a user equipment (UE) as contemplated by the present disclosure;

FIG. 4 is an example flow chart of inter radio access technology (IRAT) background public land mobile network (BPLMN) re-acquisition mechanism as contemplated by the present disclosure;

FIG. 5 is a block diagram illustrating aspects of a logical grouping of electrical components as contemplated by the present disclosure;

FIG. 6 is a block diagram illustrating aspects of a computer device according to the present disclosure;

FIG. 7 is a block diagram illustrating an example of a hardware implementation for an apparatus employing a processing system;

FIG. 8 is a block diagram conceptually illustrating an example of a telecommunications system;

FIG. 9 is a conceptual diagram illustrating an example of an access network; and

FIG. 10 is a block diagram conceptually illustrating an example of a NodeB in communication with a UE in a telecommunications system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The present disclosure presents an example method and apparatus for inter-radio access technology (IRAT) background public land mobile network (BPLMN) re-acquisition mechanism at a user equipment (UE). For example, the present disclosure presents an example method for inter-radio access technology (IRAT) background public land mobile network (BPLMN) re-acquisition mechanism at a user equipment (UE) that includes performing a BPLMN acquisition mechanism at a UE, checking whether a BPLMN re-acquisition mechanism is valid based on whether a re-acquisition flag is set, determining whether the re-acquisition mechanism requirements are met, and performing the re-acquisition mechanism at the UE.

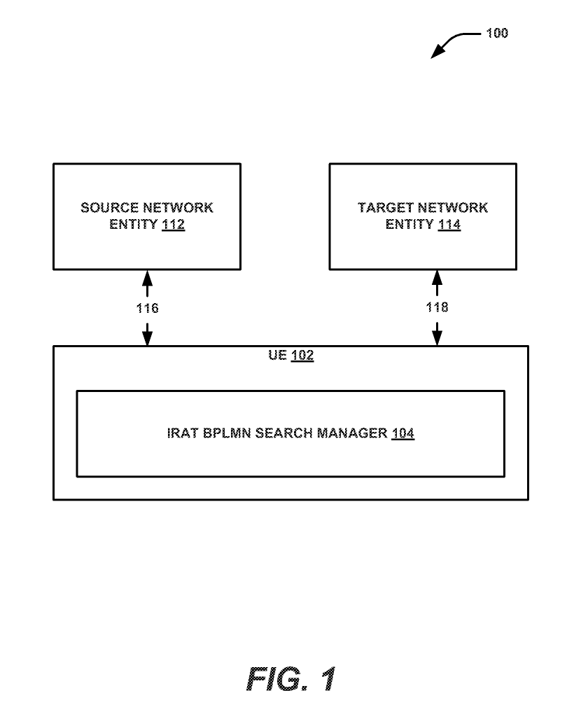

Referring to FIG. 1, a wireless communication system 100 is illustrated that facilitates an optimized inter-radio access technology (IRAT) background public land mobile network (BPLMN) acquisition mechanism at a user equipment (UE). System 100 includes user equipment (UE) 102 that may communicate with one or more network entities, for example, network entity 112 and/or network entity 114, via one or more over-the-air links 116 and/or 118, respectively. In an aspect, UE 102 may be a mobile apparatus and may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

In an aspect, network entity 112 and/or 114 may include, but are not limited to, an access point, a base station (BS) or Node B or eNodeB, a macro cell, a femtocell, a pico cell, a relay, a peer-to-peer device, an authentication, authorization and accounting (AAA) server, a mobile switching center (MSC), etc. Additionally, network entity 112 and/or 114 may include one or more of any type of network component that can enable UE 102 to communicate and/or establish and maintain link 116 and/or 118 to respectively communicate with network entity 112 and/or network entity 114.

Furthermore, the one or more network entities 114 may be, or be associated with, a candidate for cell reselection when UE 102 performs a inter-radio access technology (IRAT) background public land mobile network (BPLMN) acquisition mechanism.

In an example aspect, network entity 112 may operate according to any 2G, 3G, or 4G radio access technology (RAT) as defined in 3GPP Specifications, except Time Division Synchronous Code Division Multiple Access (TD-SCDMA). For example, the RAT may include, but not limited to Global System for Mobile Communications (GSM), Code Division Multiple Access (CDMA), Wideband-CDMA (W-CDMA), High Speed Packet Access (HSPA), or Long Term Evolution (LTE). In an aspect, network entity 114 may operate according to any of the RAT standards described above including TD-SCDMA.

Furthermore, UE 102 may include an IRAT BPLMN search manager 104 which may be configured for IRAT BPLMN re-acquisition mechanism at the UE that includes performing a BPLMN acquisition mechanism at a UE, checking whether a BPLMN re-acquisition mechanism is valid based on whether a re-acquisition flag is set, determining whether the re-acquisition mechanism requirements are met, and performing the re-acquisition mechanism at the UE.

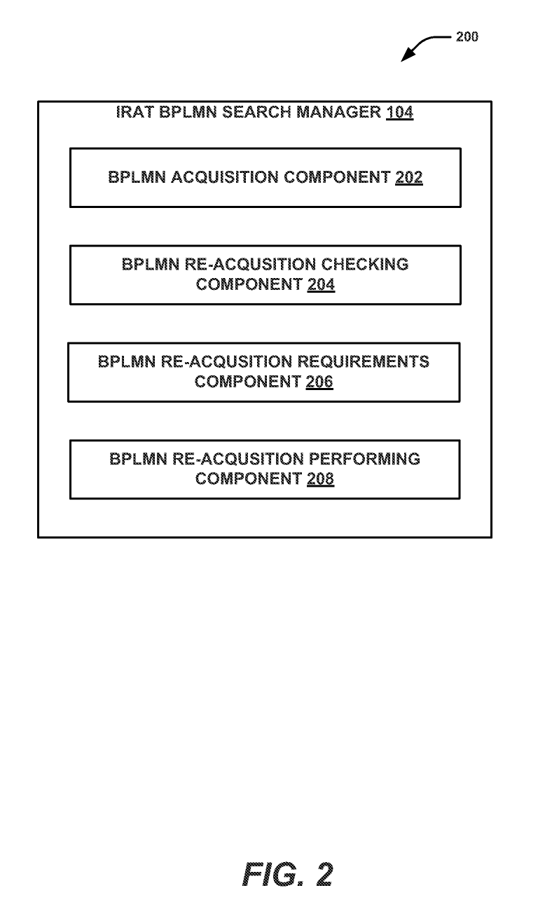

FIG. 2 illustrates an example IRAT BPLMN search manager 104 and various components that may be included in some aspects of IRAT BPLMN search manager 104 for IRAT BPLMN re-acquisition mechanism.

For example, in an aspect, IRAT BPLMN search manager 104 may include one or more of a BPLMN acquisition component 202, a BPLMN re-acquisition checking component 204, a BPLMN re-acquisition requirements component 206, and/or a BPLMN re-acquisition performing component 208.

In an aspect of inter-RAT BPLMN search, the time left for BPLMN search in the inactive RAT may not be enough as the UE has to switch back and forth between the active and the inactive RAT. For example, when TD-SCDMA is not the active RAT, the time left for TD-SCDMA to perform the BPLMN search is very small, for example, around 200 ms or less.

In an example aspect, a BPLMN search in TD-SCDMA may involve co-operation between two layers, e.g., Radio Resource Control (RRC) of layer 3 (L3) and the physical layer of Layer 1 (L1). The BPLMN search may include acquisition of a cell and/or reading system information. For example, the acquisition may include the RRC issuing an acquisition request with a given frequency to the L1 and the L1 responding with a list of cells acquired on given frequency. The acquisition may further include gap detection on a frequency for determining sub-frame boundaries, midamble decoding for getting Cell Parameters IDs (CPIDs) on the frequency, and/or P-CCPCH decoding to determine the Transmission Time Interval (TTI) boundary. Furthermore, the reading of system information may include the RRC setting up P-CCPCH channel to read Master Information Block (MIB) and/or System Information Block Type 1 (SIB1) and System Information Block Type 3 (SIB3) messages.

The time that may be needed for each BPLMN search during a DRX cycle. As a result the UE may stop the acquisition on the inactive RAT and transition back to the active RAT and re-start the acquisition mechanism at the start of the next DRX cycle. However, this is not efficient as the UE has to perform the same process again.

In an aspect, a re-acquisition mechanism is disclosed which does not require gap detection on a frequency for determining sub-frame boundaries, midamble decoding for getting Cell Parameters IDs (CPIDs) on the frequency, and/or P-CCPCH decoding to determine the Transmission Time Interval (TTI) boundary when re-acquisition mechanism requirements are met, for example, same cell and/or same frequency that was previously acquired. However, the re-acquisition mechanism is not suitable for initial acquisition and/or when the acquisition is on different cell and/or frequency compared to the initial acquisition.

In an aspect, BPLMN acquisition component 202 may be configured to perform a BPLMN acquisition mechanism at a UE, BPLMN re-acquisition checking component 204 may be configured to check whether a BPLMN re-acquisition mechanism is valid based on whether a re-acquisition flag is set, BPLMN re-acquisition requirements component 206 may be configured to determine whether the re-acquisition mechanism requirements are met, and BPLMN re-acquisition performing component may be configured to perform the re-acquisition mechanism at the UE.

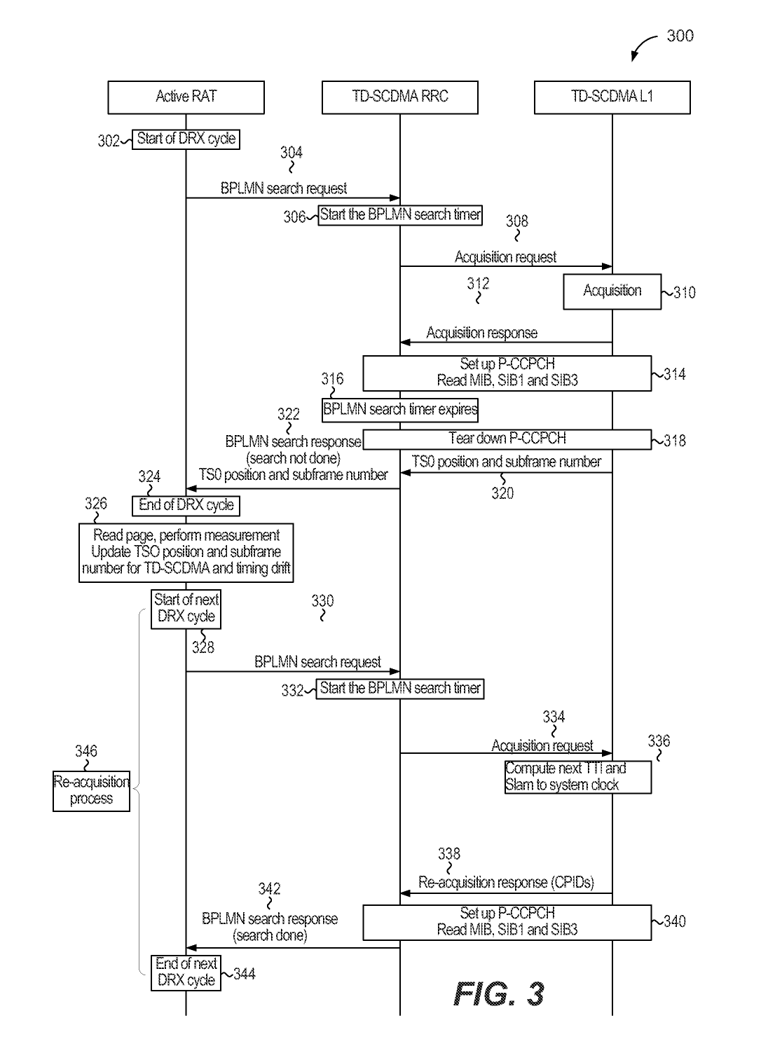

FIG. 3 illustrates an example aspect of a flow diagram 300 for inter-radio access technology (IRAT) background public land mobile network (BPLMN) re-acquisition mechanism at a user equipment (UE). For example, flow diagram 300 illustrates TRAT BPLMN re-acquisition from non-SCDMA RAT (e.g., W-CDMA or LTE) to a SCDMA RAT.

In an aspect, at step 302, a DRX cycle starts at UE 102. At step 304, BPLMN acquisition component 202 may send a search request from an active RAT to an inactive RAT to trigger a BPLMN acquisition mechanism at the UE. At step 306, BPLMN acquisition component 202 may start a BPLMN search timer at the RRC to track the time as a limited amount of time is available for searching a cell of the inactive RAT.

At step 308, BPLMN acquisition component 202 may send an acquisition request with a given frequency. For example, in an aspect, BPLMN acquisition component 202 may issue an acquisition request with a given frequency from the RRC to the L1. At step 310, BPLMN acquisition component 202 performs an acquisition mechanism at the L1 that may include gap detection on the frequency for determining sub-frame boundaries, midamble decoding for obtaining Cell Parameter IDs (CPID) on the frequency, and P-CCPCH decoding to determine the Transmission Time Interval (TTI) boundaries. At step 312, BPLMN acquisition component 202 transmits the acquisition response from the L1 to the RRC.

At step 314, once the RRC receives the acquisition response from the L1, the BPLMN acquisition component 202 may set up P-CCPCH and optionally try to read MIB and/or SIB messages. However, the BPLMN search timer may expire at step 316 and the BPLMN acquisition component 202 may tear down the P-CCPCH at step 318.

At step 320, BPLMN acquisition component 202 may report TS0 position and sub-frame number from the L1 to the RRC. At step 322, BPLMN acquisition component 202 may further report the TS0 position and the sub-frame number to the active RAT, and the current DRX cycles ends at step 324.

In an aspect, at step 326, BPLMN re-acquisition checking component 204 maintains system clock of the inactive RAT at the active RAT. However, after control goes back to the inactive RAT during the next DRX cycle for BPLMN search, the inactive RAT maintains and updates the system clock. For example, in an aspect, when the inactive RAT is TD-SCDMA, the active RAT may read paging messages, perform measurements, update TS0 position and sub-frame number for the inactive RAT and measure the timing draft.

In an aspect, at step 328, the next DRX cycle starts at UE 102. At step 330, BPLMN re-acquisition checking component 204 sends updated TS0 position and sub-frame number together with its own total timing drift during this period to the inactive RAT, e.g., TD-SCDMA. At step 332, the inactive RAT resumes BPLMN search. In an additional aspect, BPLMN re-acquisition checking component 204 may check if a resume flag is set and retrieves frequency and CPID for the previously acquired cell. If the resume flag is set, there is no need to perform the acquisition mechanism described above and instead a re-acquisition mechanism may be performed if the re-acquisition requirements are met.

In an aspect, BPLMN re-acquisition requirements component 206 may determine if the frequency is the same as the previous BPLMN searched frequency. If it is determined that the frequency is the same, BPLMN re-acquisition requirements component 206 may indicate that a re-acquisition mechanism may be performed. In an additional or optional aspect, as long as both CPID and frequency are the same, the re-acquisition mechanism may be performed. In a further additional or optional aspect, the timing drift of the Time Tracking Loop (TTL) may be compared between the current and the previous BPMLM searches. If the timing draft is larger than a threshold value, an acquisition (not a re-acquisition) is performed. If the timing drift is smaller than the threshold value, then a re-acquisition mechanism is performed.

In an additional aspect, the active RAT may compute the timing drift based on the active RAT's time-tracking loop operations to maintain timing accuracy for the in-active RAT's timing. The active RAT then computes the cumulative timing drift in-between consecutive BPLMN search commands and sends the cumulative timing drift to the inactive RAT. The inactive RAT may then take this cumulative timing drift information and may adjust the inactive RAT relevant system time. In an additional aspect, this may be followed by a re-acquisition mechanism to further adjust timing drifts (from the time the Active RAT last computed timing drift to the time BPLMN search command was sent to the Inactive RAT). In an additional or optional aspect, a combination of one or approaches described above may be used to perform the re-acquisition mechanism.

At step 334, BPLMN re-acquisition performing component 208 may send a re-acquisition request to the L1 from the RRC of the inactive RAT. In an additional aspect, if a valid TS0 position and a sub-frame number are also received from the active RAT, the RRC may send the valid TS0 position and the sub-frame number to the L1 to assist with the re-acquisition mechanism. At step 336, the L may use TS0 position with the sub-frame number received from the RRC to compute the next sub-frame on the current frequency and synchronize with the TD-SCDMA system clock so that the UE becomes synchronized with network.

At step 338, BPLMN re-acquisition performing component 208 transmits the updated cell information from the L1 to the RRC via a re-acquisition response. At step 340, BPLMN re-acquisition performing component 208 sets up P-CCPCH on the cell and starts reading MIB and/or SIBs. In an acquisition mechanism (for example, when compared to the re-acquisition mechanism), there may not be enough time for the inactive RAT to read MIB and/or SIB in the first DRX cycle, but the UE may likely succeed in the following DRX cycles as additional time for acquisition is available, if the acquisition is performed on the same cell. Thus, an IRAT BPLMN re-acquisition mechanism at the UE may be performed.

At step 342, BPLMN re-acquisition performing component 208 transmits the results of the BPLMN search to the active RAT and at step 344 the DRX cycle ends. As described above, the re-acquisition mechanism 346 occurs from steps 328-344.

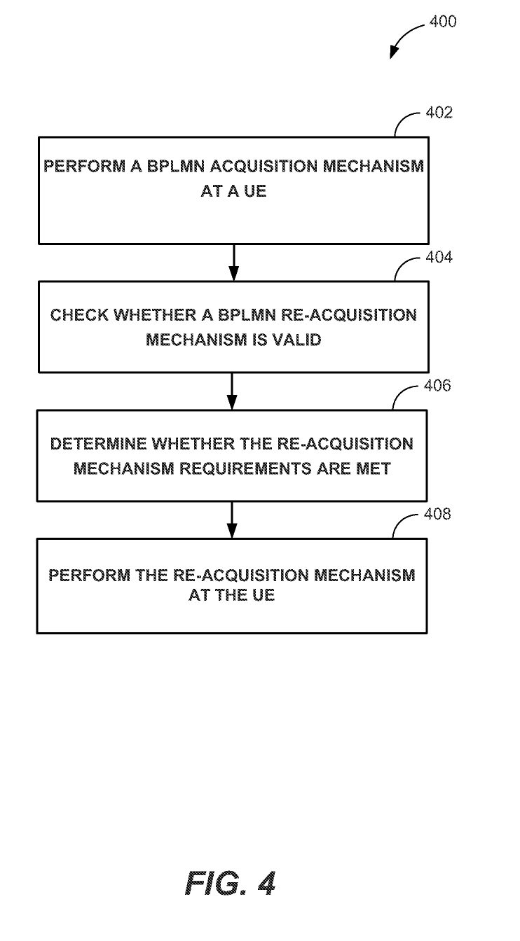

FIG. 4 illustrates an example methodology 400 for inter-radio access technology (IRAT) background public land mobile network (BPLMN) re-acquisition mechanism at a UE. In an aspect, at block 402, methodology 400 may include performing a BPLMN acquisition mechanism at a UE. For example, in an aspect, IRAT BPLMN search manager 104 and/or BPLMN acquisition component 202 may be configured to perform a BPLMN acquisition mechanism at UE 102.

Additionally, at block 404, methodology 400 may include checking whether a BPLMN re-acquisition mechanism is valid based on whether a re-acquisition flag is set. For example, in an aspect, IRAT BPLMN search manager 104 and/or BPLMN re-acquisition checking component 204 may be configured to check whether the re-acquisition flag is set at the UE.

Further, at block 406, methodology 400 may include determining whether the re-acquisition mechanism requirements are met. For example, in an aspect, IRAT BPLMN search manager 104 and/or BPLMN re-acquisition requirements component 206 may be configured to determine whether the re-acquisition mechanism requirements are met.

Furthermore, at block 408, methodology 400 may include performing the re-acquisition mechanism at the UE. For example, in an aspect, IRAT BPLMN search manager 104 and/or BPLMN re-acquisition performing component 208 may perform the re-acquisition mechanism at the UE.

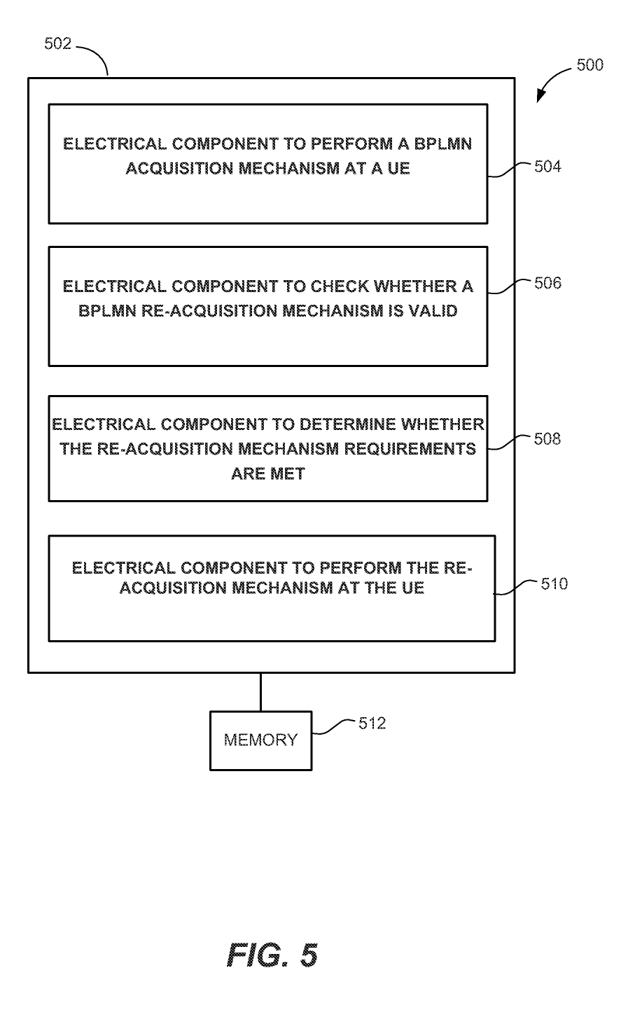

Referring to FIG. 5, an example system 500 is displayed for inter-radio access technology (IRAT) background public land mobile network (BPLMN) re-acquisition mechanism at a UE. For example, system 500 can reside at least partially within a user equipment, for example, UE 102 (FIG. 1) and/or IRAT BPLMN search manager 104 (FIGS. 1-2). It is to be appreciated that system 500 is represented as including functional blocks, which can be functional blocks that represent functions implemented by a processor, software, or combination thereof (for example, firmware). System 500 includes a logical grouping 502 of electrical components that can act in conjunction. For instance, logical grouping 502 may include an electrical component 504 to perform a BPLMN acquisition mechanism at a UE. In an aspect, electrical component 504 may comprise IRAT BPLMN search manager 104 (FIGS. 1-2) and/or BPLMN acquisition component 202 (FIG. 2).

Additionally, logical grouping 502 may include an electrical component 506 to check whether a BPLMN re-acquisition mechanism is valid based on whether a re-acquisition flag is set. In an aspect, electrical component 506 may comprise IRAT BPLMN search manager 104 (FIGS. 1-2) and/or BPLMN re-acquisition checking component 204 (FIG. 2).

Further, logical grouping 502 may include an electrical component 508 to determine whether the re-acquisition mechanism requirements are met. In an aspect, electrical component 508 may comprise IRAT BPLMN search manager 104 (FIGS. 1-2) and/or BPLMN re-acquisition requirement component 206 (FIG. 2).

Furthermore, logical grouping 502 can include an electrical component 510 to perform the re-acquisition mechanism at the UE. In an aspect, electrical component 510 may comprise IRAT BPLMN search manager 104 (FIGS. 1-2) and/or BPLMN re-acquisition performing component 208 (FIG. 2).

Additionally, system 500 can include a memory 512 that retains instructions for executing functions associated with the electrical components 504, 506, 508, and 510, stores data used or obtained by the electrical components 504, 506, 508, and 510, etc. While shown as being external to memory 512 it is to be understood that one or more of the electrical components 504, 506, 508, and 510 can exist within memory 512. In one example, electrical components 504, 506, 508, and 510 can comprise at least one processor, or each electrical component 504, 506, 508, and 510 can be a corresponding module of at least one processor. Moreover, in an additional or alternative example, electrical components 504, 506, 508, and 510 can be a computer program product including a computer readable medium, where each electrical component 504, 506, 508, and 510 can be corresponding code.

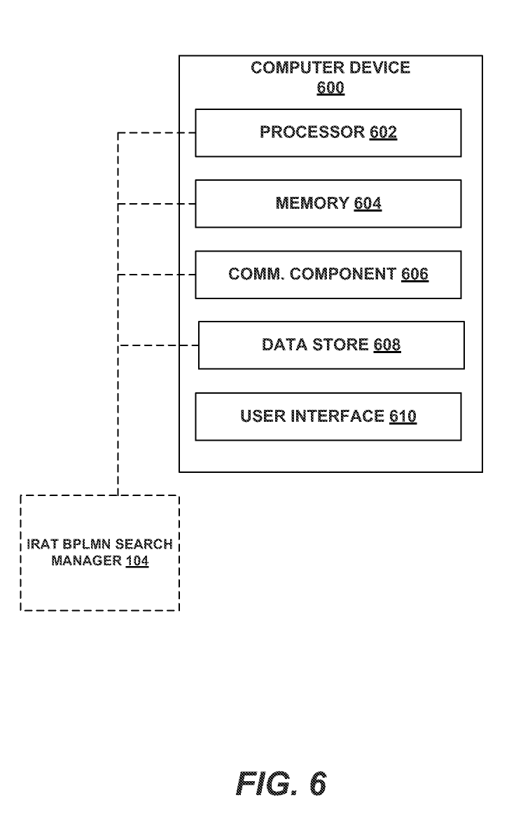

Referring to FIG. 6, in one aspect, UE 102 and/or IRAT BPLMN search manager 104 may be represented by a specially programmed or configured computer device 600. In one aspect of implementation, computer device 600 may include IRAT BPLMN search manager 104 (FIGS. 1-2), such as in specially programmed computer readable instructions or code, firmware, hardware, or some combination thereof. Computer device 600 includes a processor 602 for carrying out processing functions associated with one or more of components and functions described herein. Processor 602 can include a single or multiple set of processors or multi-core processors. Moreover, processor 602 can be implemented as an integrated processing system and/or a distributed processing system.

Computer device 600 further includes a memory 604, such as for storing data used herein and/or local versions of applications being executed by processor 602. Memory 604 can include any type of memory usable by a computer, such as random access memory (RAM), read only memory (ROM), tapes, magnetic discs, optical discs, volatile memory, non-volatile memory, and any combination thereof.

Further, computer device 600 includes a communications component 606 that provides for establishing and maintaining communications with one or more parties utilizing hardware, software, and services as described herein. Communications component 606 may carry communications between components on computer device 600, as well as between computer device 600 and external devices, such as devices located across a communications network and/or devices serially or locally connected to computer device 600. For example, communications component 606 may include one or more buses, and may further include transmit chain components and receive chain components associated with a transmitter and receiver, respectively, or a transceiver, operable for interfacing with external devices. In an additional aspect, communications component 606 may be configured to receive one or more pages from one or more subscriber networks. In a further aspect, such a page may correspond to the second subscription and may be received via the first technology type communication services.

Additionally, computer device 600 may further include a data store 608, which can be any suitable combination of hardware and/or software, that provides for mass storage of information, databases, and programs employed in connection with aspects described herein. For example, data store 608 may be a data repository for applications not currently being executed by processor 602 and/or any threshold values or finger position values.

Computer device 600 may additionally include a user interface component 610 operable to receive inputs from a user of computer device 600 and further operable to generate outputs for presentation to the user. User interface component 610 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 610 may include one or more output devices, including but not limited to a display, a speaker, a haptic feedback mechanism, a printer, any other mechanism capable of presenting an output to a user, or any combination thereof.

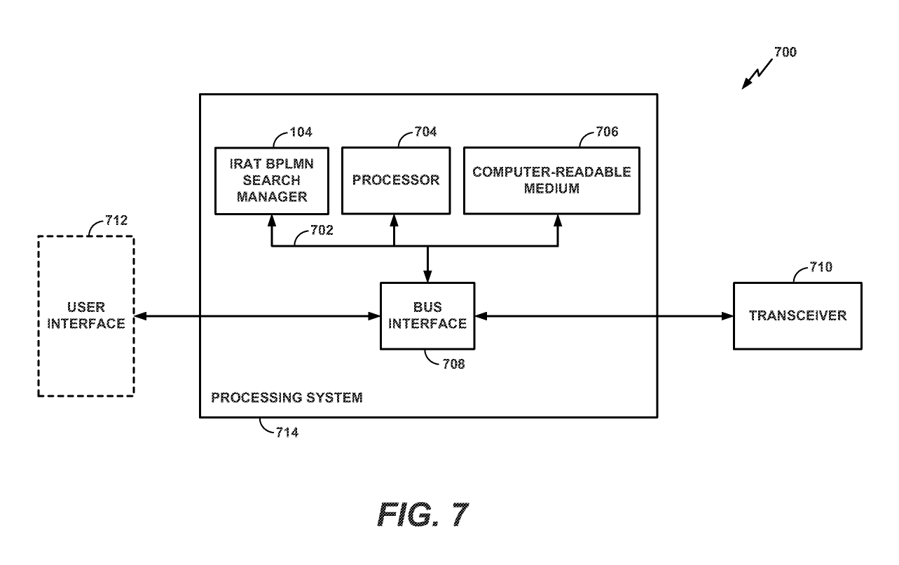

FIG. 7 is a block diagram illustrating an example of a hardware implementation for an apparatus 700, for example, including IRAT BPLMN search manager 104 (FIGS. 1-2), employing a processing system 714 for carrying out aspects of the present disclosure, such as a method for IRAT BPLMN acquisition mechanism. In this example, the processing system 714 may be implemented with bus architecture, represented generally by a bus 702. The bus 702 may include any number of interconnecting buses and bridges depending on the specific application of the processing system 714 and the overall design constraints. The bus 702 links together various circuits including one or more processors, represented generally by the processor 704, computer-readable media, represented generally by the computer-readable medium 706, and one or more components described herein, such as, but not limited to, IRAT BPLMN search manager 104, BPLMN acquisition component 202, BPLMN re-acquisition component 204, BPLMN re-acquisition requirements component 206, and/or BPLMN re-acquisition performing component 208 (FIGS. 1-2). The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable medium 706. The software, when executed by the processor 704, causes the processing system 714 to perform the various functions described infra for any particular apparatus. The computer-readable medium 706 may also be used for storing data that is manipulated by the processor 704 when executing software.

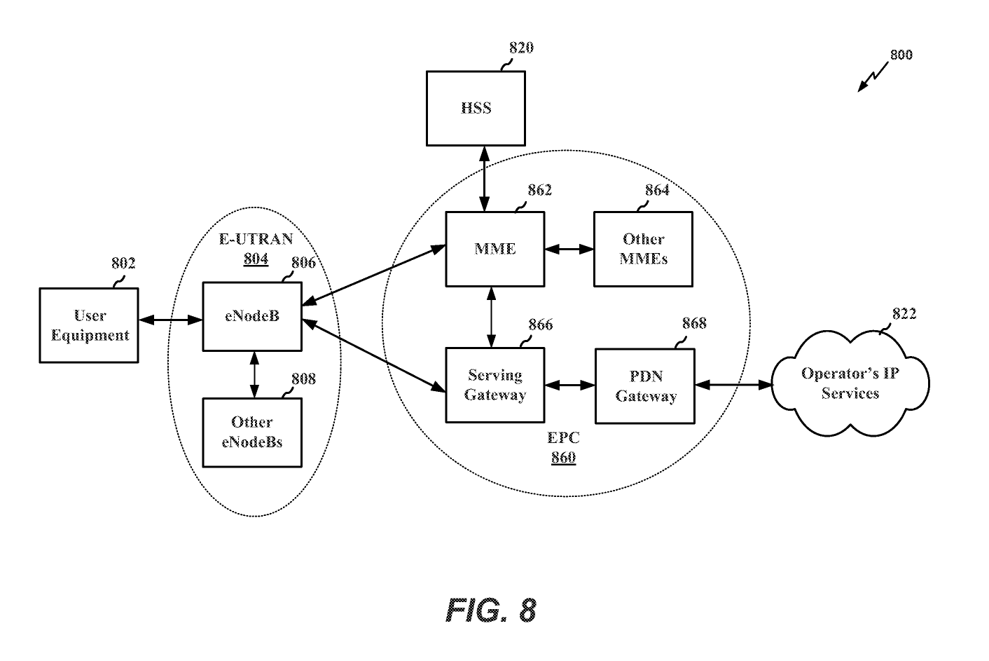

FIG. 8 is a diagram illustrating a long term evolution (LTE) network architecture 800 employing various apparatuses of wireless communication system 100 (FIG. 1) and may include one or more user equipment (UE) configured to include an IRAT BPLMN search manager 104 (FIG. 1). The LTE network architecture 800 may be referred to as an Evolved Packet System (EPS) 800. EPS 800 may include one or more user equipment (UE) 802, an Evolved UMTS Terrestrial Radio Access Network (E-UTRAN) 804, an Evolved Packet Core (EPC) 860, a Home Subscriber Server (HSS) 820, and an Operator's IP Services 822. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 806 and other eNBs 808. The eNB 806 provides user and control plane protocol terminations toward the UE 802. The eNB 806 may be connected to the other eNBs 808 via an X2 interface (i.e., backhaul). The eNB 806 may also be referred to by those skilled in the art as a base station, a base transceiver station, a radio base station, a radio transceiver, a transceiver function, a basic service set (BSS), an extended service set (ESS), or some other suitable terminology. The eNB 806 provides an access point to the EPC 860 for a UE 802. Examples of UEs 802 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 802 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 806 is connected by a S1 interface to the EPC 860. The EPC 860 includes a Mobility Management Entity (MME) 862, other MMEs 864, a Serving Gateway 866, and a Packet Data Network (PDN) Gateway 868. The MME 862 is the control node that processes the signaling between the UE 802 and the EPC 860. Generally, the MME 862 provides bearer and connection management. All user IP packets are transferred through the Serving Gateway 866, which itself is connected to the PDN Gateway 868. The PDN Gateway 868 provides UE IP address allocation as well as other functions. The PDN Gateway 868 is connected to the Operator's IP Services 822. The Operator's IP Services 822 includes the Internet, the Intranet, an IP Multimedia Subsystem (IMS), and a PS Streaming Service (PSS).

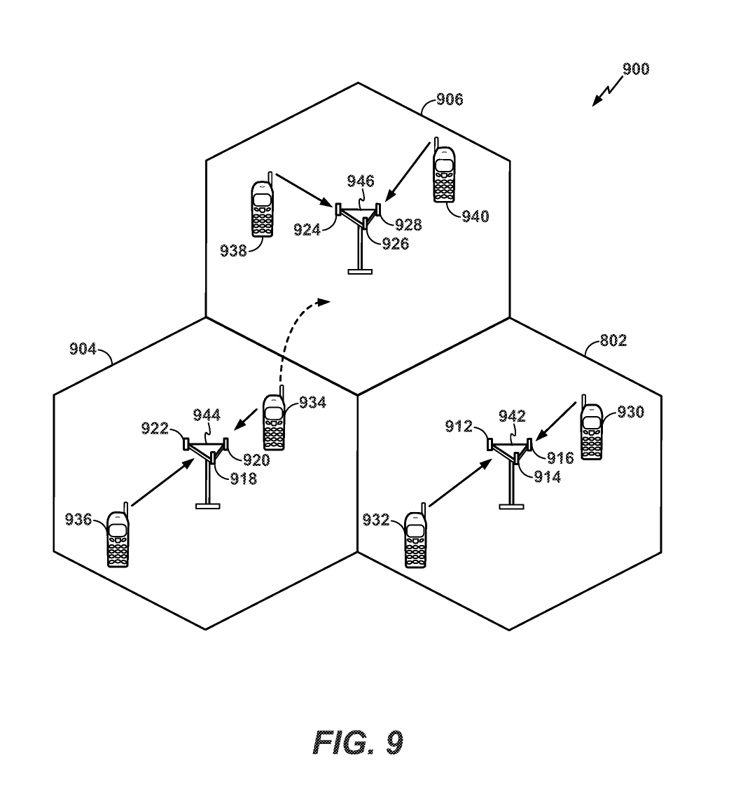

Referring to FIG. 9, an access network 900 in a UTRAN architecture is illustrated, and may include one or more user equipment (UE) configured to include an IRAT BPLMN search manager 104 (FIGS. 1-2). The multiple access wireless communication system includes multiple cellular regions (cells), including cells 902, 904, and 906, each of which may include one or more sectors and which may base network entity 112 and/or network entity 114 of FIG. 1. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 each correspond to a different sector. In cell 906, antenna groups 924, 926, and 928 each correspond to a different sector. The cells 902, 904 and 906 may include several wireless communication devices, e.g., User Equipment or UEs, for example, including UE 102 of FIG. 1, which may be in communication with one or more sectors of each cell 902, 904 or 906. For example, UEs 930 and 932 may be in communication with NodeB 942, UEs 934 and 936 may be in communication with NodeB 944, and UEs 938 and 940 can be in communication with NodeB 946. Here, each NodeB 942, 944, 946 is configured to provide an access point for all the UEs 930, 932, 934, 936, 939, 940 in the respective cells 902, 904, and 906. Additionally, each NodeB 942, 944, 946 may be network entity 112,114 of FIG. 1, and/or each UE 930, 932, 934, 936, 939, 940 may be UE 102 of FIG. 1, and may perform the methods outlined herein.

As the UE 934 moves from the illustrated location in cell 904 into cell 906, a serving cell change (SCC) or handover may occur in which communication with the UE 934 transitions from the cell 904, which may be referred to as the source cell, to cell 906, which may be referred to as the target cell. Management of the handover procedure may take place at the UE 934, at the Node Bs corresponding to the respective cells, at EPC 860 (FIG. 8), or at another suitable node in the wireless network. For example, during a call with the source cell 904, or at any other time, the UE 934 may monitor various parameters of the source cell 904 as well as various parameters of neighboring cells such as cells 906 and 902. Further, depending on the quality of these parameters, the UE 934 may maintain communication with one or more of the neighboring cells. During this time, the UE 934 may maintain an Active Set, that is, a list of cells that the UE 934 is simultaneously connected to (i.e., the UTRA cells that are currently assigning a downlink dedicated physical channel DPCH or fractional downlink dedicated physical channel F-DPCH to the UE 934 may constitute the Active Set). In any case, UE 934 may execute IRAT BPLMN search manager 104 to perform the optimized inter-radio access technology (IRAT) background public land mobile network (BPLMN) acquisition mechanism operations described herein.

Further, the modulation and multiple access scheme employed by the access network 900 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA: Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

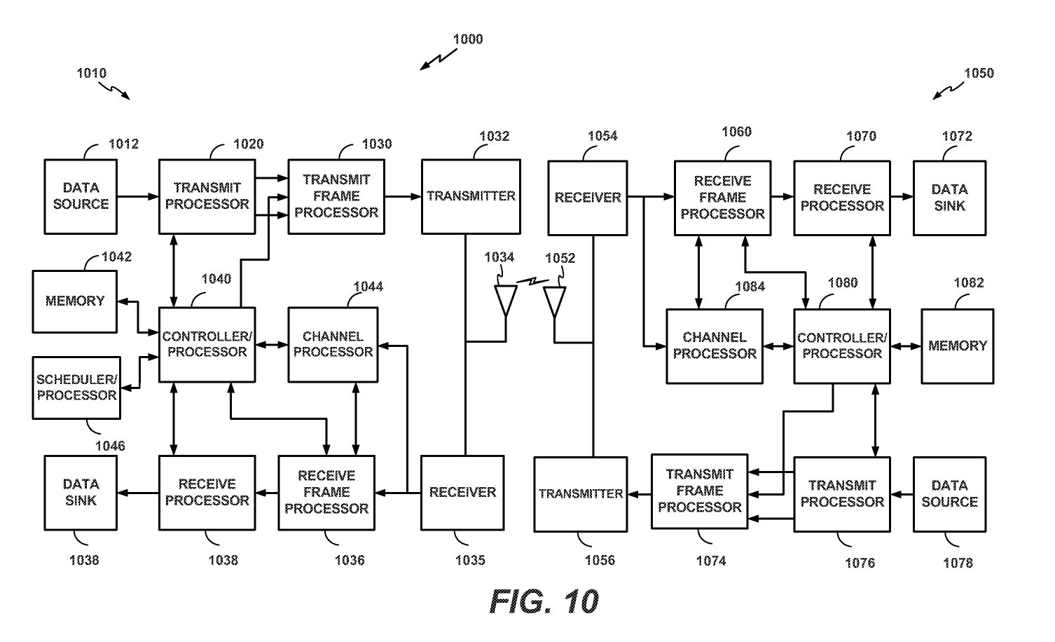

FIG. 10 is a block diagram of a NodeB 1010 in communication with UE 1050, where the NodeB 1010 may be network entity 112 and/or network entity 114, and where UE 1050 may be UE 102 that may include an IRAT BPLMN search manager 104 (FIGS. 1-2). In the downlink communication, a transmit processor 1020 may receive data from a data source 1012 and control signals from a controller/processor 1040. The transmit processor 1020 provides various signal processing functions for the data and control signals, as well as reference signals (e.g., pilot signals). For example, the transmit processor 1020 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1044 may be used by a controller/processor 1040 to determine the coding, modulation, spreading, and/or scrambling schemes for the transmit processor 1020. These channel estimates may be derived from a reference signal transmitted by the UE 1050 or from feedback from the UE 1050. The symbols generated by the transmit processor 1020 are provided to a transmit frame processor 1030 to create a frame structure. The transmit frame processor 1030 creates this frame structure by multiplexing the symbols with information from the controller/processor 1040, resulting in a series of frames. The frames are then provided to a transmitter 1032, which provides various signal conditioning functions including amplifying, filtering, and modulating the frames onto a carrier for downlink transmission over the wireless medium through antenna 1034. The antenna 1034 may include one or more antennas, for example, including beam steering bidirectional adaptive antenna arrays or other similar beam technologies.

At the UE 1050, a receiver 1054 receives the downlink transmission through an antenna 1052 and processes the transmission to recover the information modulated onto the carrier. The information recovered by the receiver 1054 is provided to a receive frame processor 1060, which parses each frame, and provides information from the frames to a channel processor 1084 and the data, control, and reference signals to a receive processor 1070. The receive processor 1070 then performs the inverse of the processing performed by the transmit processor 1020 in the NodeB 1010. More specifically, the receive processor 1070 descrambles and de-spreads the symbols, and then determines the most likely signal constellation points transmitted by the NodeB 1010 based on the modulation scheme. These soft decisions may be based on channel estimates computed by the channel processor 1084. The soft decisions are then decoded and de-interleaved to recover the data, control, and reference signals. The CRC codes are then checked to determine whether the frames were successfully decoded. The data carried by the successfully decoded frames will then be provided to a data sink 1072, which represents applications running in the UE 1050 and/or various user interfaces (e.g., display). Control signals carried by successfully decoded frames will be provided to a controller/processor 1080. When frames are unsuccessfully decoded by the receiver processor 1070, the controller/processor 1080 may also use an acknowledgement (ACK) and/or negative acknowledgement (NACK) protocol to support retransmission requests for those frames.

In the uplink, data from a data source 1078 and control signals from the controller/processor 1080 are provided to a transmit processor 1076. The data source 1078 may represent applications running in the UE 1050 and various user interfaces (e.g., keyboard). Similar to the functionality described in connection with the downlink transmission by the NodeB 1010, the transmit processor 1076 provides various signal processing functions including CRC codes, coding and interleaving to facilitate FEC, mapping to signal constellations, spreading with OVSFs, and scrambling to produce a series of symbols. Channel estimates, derived by the channel processor 1084 from a reference signal transmitted by the NodeB 1010 or from feedback contained in the midamble transmitted by the NodeB 1010, may be used to select the appropriate coding, modulation, spreading, and/or scrambling schemes. The symbols produced by the transmit processor 1076 will be provided to a transmit frame processor 1074 to create a frame structure. The transmit frame processor 1074 creates this frame structure by multiplexing the symbols with information from the controller/processor 1080, resulting in a series of frames. The frames are then provided to a transmitter 1056, which provides various signal conditioning functions including amplification, filtering, and modulating the frames onto a carrier for uplink transmission over the wireless medium through the antenna 1052.

The uplink transmission is processed at the NodeB 1010 in a manner similar to that described in connection with the receiver function at the UE 1050. A receiver 1035 receives the uplink transmission through the antenna 1034 and processes the transmission to recover the information modulated onto the carrier. The information recovered by the receiver 1035 is provided to a receive frame processor 1036, which parses each frame, and provides information from the frames to the channel processor 1044 and the data, control, and reference signals to a receive processor 1038. The receive processor 1038 performs the inverse of the processing performed by the transmit processor 1076 in the UE 1050. The data and control signals carried by the successfully decoded frames may then be provided to a data sink 1038 and the controller/processor, respectively. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1080 may be used to direct the operation at the NodeB 1010 and the UE 1050, respectively. For example, the controller/processors 1040 and 1080 may provide various functions including timing, peripheral interfaces, voltage regulation, power management, and other control functions. The computer readable media of memories 1042 and 1082 may store data and software for the NodeB 1010 and the UE 1050, respectively. A scheduler/processor 1046 at the NodeB 1010 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer.

The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for inter-radio access technology (IRAT) background public land mobile network (BPLMN) re-acquisition mechanism at a user equipment (UE), comprising:
performing a BPLMN acquisition mechanism at a UE;
checking whether a BPLMN re-acquisition mechanism is valid based on whether a re-acquisition flag is set;
determining whether the re-acquisition mechanism requirements are met; and
performing the re-acquisition mechanism at the UE.

2. The method of claim 1, wherein the BPLMN acquisition mechanism at the UE comprises:
acquiring a frequency of a cell;
checking whether there is enough time in a first DRX cycle to read a master information block (MIB) or a system information block (SIB);
saving information of the cell at an inactive radio access technology (RAT) when it is determined that there is not enough time in the first DRX cycle to read the MIB or the SIB;
retrieving a sub-frame start position (TS0) and a sub-frame number from the inactive RAT; and
transmitting the retrieved information to an active RAT.

3. The method of claim 2, wherein the information saved comprises the frequency of the cell and a cell parameter ID (CPID).

4. The method of claim 2, further comprising:
setting a re-acquisition flag at the inactive RAT when the MIB or the SIB is not read during the first DRX cycle of the BPLMN acquisition mechanism.

5. The method of claim 1, wherein the determining further comprises:
computing a timing drift;
determining that the re-acquisition requirements are not met when the computed timing drift is above a threshold value.

6. The method of claim 1, wherein the BPLMN re-acquisition mechanism further comprises:
synchronizing timing of the UE with the inactive RAT;
setting up a primary physical common control channel (P-CCPCH); and
reading a master information block or a system information block (SIB) of the inactive RAT.

7. The method of claim 6, further comprising:
computing a timing drift based on the active RAT's time-tracking loop operations to maintain timing accuracy for the in-active RAT's timing.

8. The method of claim 1, wherein the re-acquisition requirements comprise a BPLMN search frequency and a cell parameter ID (CPID).

9. The method of claim 1, wherein the BPLMN acquisition mechanism is triggered by sending a BPLMN search request message from an active RAT to an inactive RAT.

10. The method of claim 1, wherein the inactive RAT is time division synchronous code division multiple access (TD-SCDMA).

11. An apparatus for inter-radio access technology (IRAT) background public land mobile network (BPLMN) re-acquisition mechanism at a user equipment (UE), comprising:
means for performing a BPLMN acquisition mechanism at a UE;
means for checking whether a BPLMN re-acquisition mechanism is valid based on whether a re-acquisition flag is set;
means for determining whether the re-acquisition mechanism requirements are met; and
means for performing the re-acquisition mechanism at the UE.

12. The apparatus of claim 11, wherein the BPLMN acquisition mechanism at the UE comprises:
means for acquiring a frequency of a cell;
means for checking whether there is enough time in a first DRX cycle to read a master information block (MIB) or a system information block (SIB);
means for saving information of the cell at an inactive radio access technology (RAT) when it is determined that there is not enough time in the first DRX cycle to read the MIB or the SIB;
means for retrieving a sub-frame start position (TS0) and a sub-frame number from the inactive RAT; and
means for transmitting the retrieved information to an active RAT.

13. The apparatus of claim 12, wherein the information saved comprises the frequency of the cell and a cell parameter ID (CPID).

14. The apparatus of claim 12, further comprising:
means for setting a re-acquisition flag at the inactive RAT when the MIB or the SIB is not read during the first DRX cycle of the BPLMN acquisition mechanism.

15. The apparatus of claim 1, wherein the BPLMN re-acquisition mechanism further comprises:
means for synchronizing timing of the UE with the inactive RAT;
means for setting up a primary physical common control channel (P-CCPCH); and
means for reading a master information block or a system information block (SIB) of the inactive RAT.

16. The apparatus of claim 11, wherein the re-acquisition requirements comprise a BPLMN search frequency and a cell parameter ID (CPID).

17. The apparatus of claim 11, wherein the BPLMN acquisition mechanism is triggered by sending a BPLMN search request message from an active RAT to an inactive RAT.

18. The apparatus of claim 11, wherein the inactive RAT is time division synchronous code division multiple access (TD-SCDMA).

19. A computer program product for inter-radio access technology (IRAT) background public land mobile network (BPLMN) re-acquisition mechanism at a user equipment (UE), comprising:
a computer-readable medium comprising code executable by a computer for:
performing a BPLMN acquisition mechanism at a UE;
checking whether a BPLMN re-acquisition mechanism is valid based on whether a re-acquisition flag is set;
determining whether the re-acquisition mechanism requirements are met; and
performing the re-acquisition mechanism at the UE.

20. The computer program product of claim 19, wherein the BPLMN acquisition mechanism at the UE comprises:
acquiring a frequency of a cell;
checking whether there is enough time in a first DRX cycle to read a master information block (MIB) or a system information block (SIB);
saving information of the cell at an inactive radio access technology (RAT) when it is determined that there is not enough time in the first DRX cycle to read the MIB or the SIB;
retrieving a sub-frame start position (TS0) and a sub-frame number from the inactive RAT; and
transmitting the retrieved information to an active RAT.

21. The computer program product of claim 20, wherein the information saved comprises the frequency of the cell and a cell parameter ID (CPID).

22. The computer program product of claim 20, further comprising code for:
setting a re-acquisition flag at the inactive RAT when the MIB or the SIB is not read during the first DRX cycle of the BPLMN acquisition mechanism.

23. An apparatus for inter-radio access technology (IRAT) background public land mobile network (BPLMN) re-acquisition mechanism at a user equipment (UE), comprising:
a BPLMN acquisition component to perform a BPLMN acquisition mechanism at a UE;
a BPLMN re-acquisition to checking component to checking whether a BPLMN re-acquisition mechanism is valid based on whether a re-acquisition flag is set;
a BPLMN re-acquisition requirements component to determine whether the re-acquisition mechanism requirements are met; and
a BPLMN re-acquisition performing component to perform the re-acquisition mechanism at the UE.

24. The apparatus of claim 23, wherein the BPLMN acquisition component is further configured to:
acquire a frequency of a cell;
check whether there is enough time in a first DRX cycle to read a master information block (MIB) or a system information block (SIB);
save information of the cell at an inactive radio access technology (RAT) when it is determined that there is not enough time in the first DRX cycle to read the MIB or the SIB;
retrieve a sub-frame start position (TS0) and a sub-frame number from the inactive RAT; and
transmit the retrieved information to an active RAT.

25. The apparatus of claim 24, wherein the information saved comprises the frequency of the cell and a cell parameter ID (CPID).

26. The apparatus of claim 24, wherein the BPLMN acquisition component is further configured to:
set a re-acquisition flag at the inactive RAT when the MIB or the SIB is not read during the first DRX cycle of the BPLMN acquisition mechanism.

27. The apparatus of claim 23, wherein the BPLMN re-acquisition performing component is configured to:
synchronize timing of the UE with the inactive RAT;
set up a primary physical common control channel (P-CCPCH); and
read a master information block or a system information block (SIB) of the inactive RAT.

28. The apparatus of claim 23, wherein the re-acquisition requirements comprise a BPLMN search frequency and a cell parameter ID (CPID).

29. The apparatus of claim 23, wherein the BPLMN acquisition component is further configured to trigger the BPMPN acquisition mechanism by sending a BPLMN search request message from an active RAT to an inactive RAT.

30. The apparatus of claim 23, wherein the inactive RAT is time division synchronous code division multiple access (TD-SCDMA).
